(19) United States
(12) Patent Application Publication
(10) Pub. No.: US 2015/0324816 A1
(43) Pub. Date: Nov. 12, 2015

(54) PREDICTING LOCATION BASED ON PAYMENT CARD USAGE

(71) Applicant: MASTERCARD INTERNATIONAL INCORPORATED, PURCHASE, NY (US)

(72) Inventors: Kenny Unser, Fairfield, CT (US); Serge Bernard, Danbury, CT (US); Nikhil Malgatti, Stamford, CT (US)

(73) Assignee: MASTERCARD INTERNATIONAL INCORPORATED, PURCHASE, NY (US)

(21) Appl. No.: 14/270,514

(22) Filed: May 6, 2014

(51) Int. Cl. G06Q 30/02

(52) U.S. Cl. CPC G06Q 30/0202

(57) ABSTRACT

A system and a method for predicting the location of a person using prior point of sale transaction data are disclosed. Historical purchase data is used to develop logic for predicting a present or future location at any given time of the cardholder. The logic can be tested against transaction data to qualify its accuracy. Statistical techniques are used to develop the logic with a sample of payment cardholders during an analytical phase. The logic can be applied to a broader universe of cardholders to ascertain a higher level of confidence that can be assigned to the prediction.

### BACKGROUND OF THE DISCLOSURE

1. Field of the Disclosure

The present disclosure relates to the use of payment card purchase information for prediction purposes. More particularly, the present disclosure relates to predicting the location of a person based on the person's use of a payment card.

2. Description of the Related Art

The availability of payment card transaction data provides unique opportunities to service a customer using a payment card. However, one concern is security. Often, an issuer of a payment card (such as, for example, credit card, debit card, prepaid card) has security concerns when questionable transactions at points of sale occur in places far from the residence of a payment card user. Currently, there is no way to know, or even accurately predict, the location of a payment card user.

In addition to making transactions more secure, another possible benefit is that if the location of a payment card use is known, targeted advertising for that location can be sent to the user of the payment card. Thus, the user is informed of goods or services that are available at that location, and the issuer receives the possible benefit of one or more additional transactions being conducted by the payment card user.

Thus, there exists a need for a system and a method for determining or predicting, with as much certainty as possible, the location of a user of a payment card.

### SUMMARY OF THE DISCLOSURE

The present disclosure provides a system and a method for predicting the location of a user of a payment card.

The present disclosure also provides that the system and the method each use historical purchase data to develop logic for predicting the location of a person or user at any given time or the present time.

The present disclosure further provides that the logic can be tested against transaction data to determine a confidence level of the prediction.

The present disclosure still further provides that the logic can be retested against transaction data and insights to improve the confidence level of the prediction.

The present disclosure yet further provides a computer readable non-transitory storage medium that stores instructions of a computer program, which when executed by a computer system, results in performance of steps of the method for predicting the future location of a user based on the user's payment card transactions.

### BRIEF DESCRIPTION OF THE DRAWINGS

FIG. 1 is a flow chart of a method according to the present disclosure.

FIG. 2 is a logic flow, used in the flow chart of FIG. 1, to determine a location of a cardholder.

FIG. 3 is a block diagram of a portion of a payment card system used in accordance with the present disclosure.

A component or a feature that is common to more than one drawing is indicated with the same reference number in each of the drawings.

### DESCRIPTION OF THE EMBODIMENTS

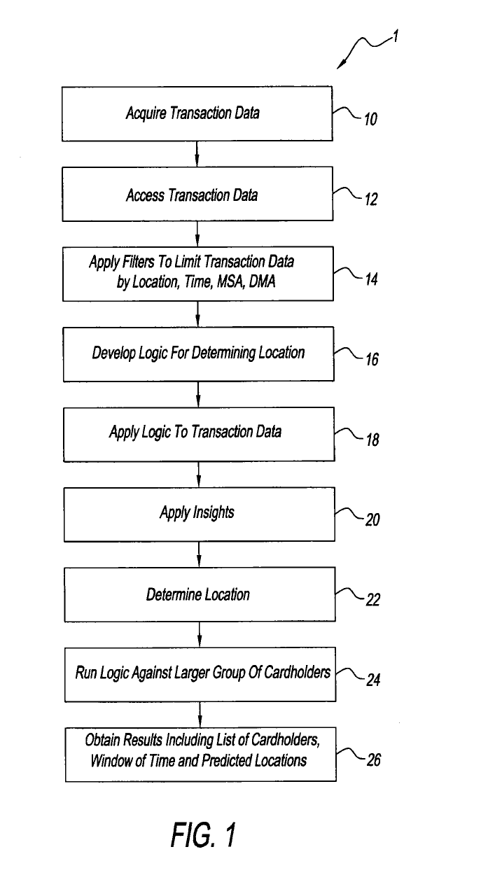

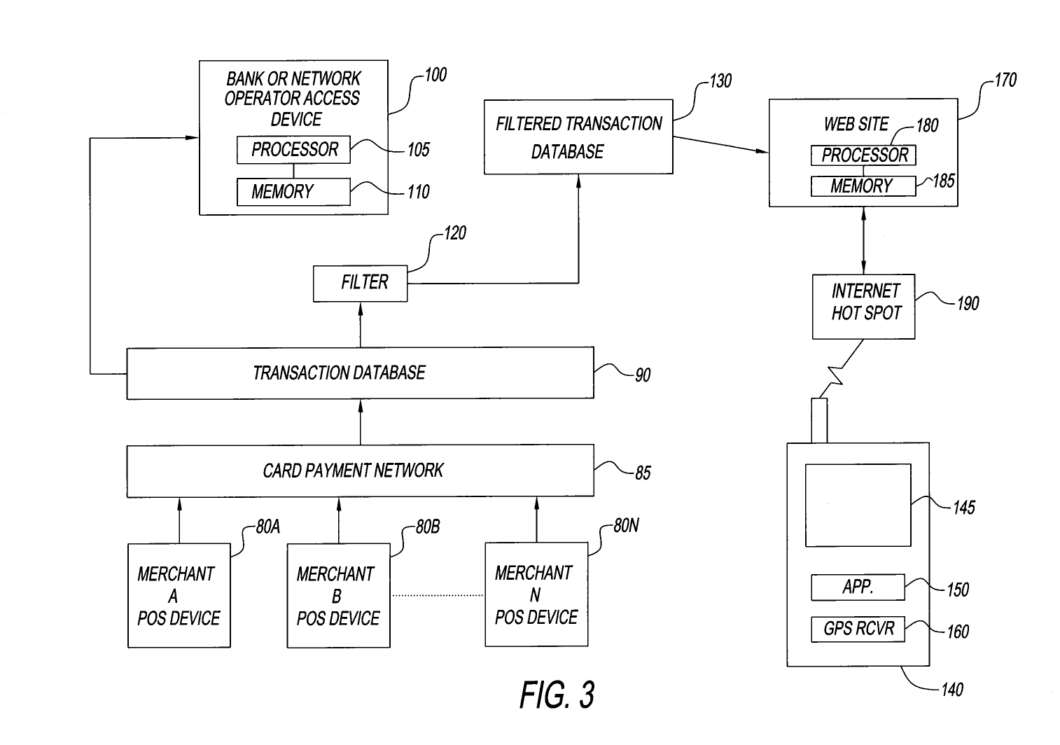

Referring to the drawings and, in particular, FIG. 1, a method of the present disclosure is generally referenced by reference numeral 1. At 10, transaction data is acquired or accessed. Such data can be obtained using the system described with respect to FIG. 3, or by other systems that are used to store such data.

Generally, the acquired transaction data is point of sale data since such data is most representative of the actual location of a user or person. However, if it is possible to verify that, for example, a home computer was used to make a purchase, that purchase is a high confidence indicator that the person who made the purchase was at home.

Relevant transaction data usually obtained for a payment card transaction includes acquirer identifier/card accepter identifier (the combination of which uniquely defines the merchant), merchant address (i.e., full address and or GPS data), merchant category code (also known as card acceptor business code) that is an indication of the type of business the merchant is involved in (for example, a gas station), local transaction date and time, cardholder base currency (i.e., U.S. Dollars, Euro, Yen, and the like), the transaction environment or method being used to conduct the transaction (point of sale by card swipe, telephone sale or web site sale), product specific data such as SKU line item data, and cost of the transaction or transactional amount.

Purchase data can be filtered by at least one of time, metropolitan statistical area, designated market area and other geographic regions, as noted below. The transaction data used for testing accuracy of prediction can be future transaction data, or data from a larger group than the one used for acquiring the original data.

Other information that is relevant is customer information, including a customer account identifier that would be anonymized (or at least filtered to remove customer account identifiers), customer geography (that would be known generally or would be modeled in some way), the type of customer (for example, consumer or business), and customer demographics. Generally, unless there is some type of consumer opt in procedure, anonymized data is used for marketing applications. A cardholder's individual data would not ordinary be used unless there was consent by that consumer. However, for strictly internal uses, such as a fraud investigation, data is not necessarily anonymized.

With respect to the merchant, external data, such as geographic grouping, metropolitan statistical area (MSA) and designated market area (DMA), can be obtained.

At 12, the transaction data acquired can be accessed to perform various functions as described below. One path for accessing the transaction data is described with respect to FIG. 3. However, transaction data can be accessed directly by the entity that customarily stores such transaction data, such as an operator of a payment card network used to settle payment card transactions.

At 14, the stored transaction data is filtered based on various criteria. One criteria is time filtering. Time filtering can include filtering transactions with respect to weekday, weekend, day verses evening, holiday schedules, school schedules (college, high school, elementary school), season, or in any number of other ways with respect to time.

Transactions or transaction data can also be sorted by other filters. Such filters can include local geographies and boundaries, as well as merchant geography groupings, and groupings by zip code, town, city, county, a selected portion of a state, a state, an ad hoc combination of any of the above and a country. Other filters are by MSA and DMA.

At 16, logic is developed for determining location. For example, transaction data can be analyzed by at least one of clustering, segmentation and ranking. The logic can include utilizing external data or organizational tools, such as Nielsen DMA or MSA. Transaction data can be classified by typical business hour (9 AM to 5 PM), shift work hours (for example 8 AM to 4 PM, 4 PM to 12 AM, and 12 AM to 8 AM). Seasonal categories of classification, such as ski season, summer break and spring break, can be used. Specific holidays, such as July 4^{th}, Labor Day, Thanksgiving and Christmas, can also be used. Cardholder specific geography classifications can also be used. For example, cardholder residence and merchant location can be combined.

Transaction data can also be classified by travel, such as, for example, foreign travel (home country is not merchant country), domestic travel (residence is 100+ miles from merchant) and commuting distance (residence is within 50 miles of merchant).

Cardholder level classifications can be used. For example, these classifications can include a time of day pattern that indicates where a cardholder transacts with merchants (for example frequent weekday lunches in New York City), the specific weeks each year during which a cardholder travels internationally (including mixed destinations), specific weeks each year during which a cardholder travels domestically (including mixed destinations), specific weeks of the year during which a cardholder travels to a specific location (for example, Thanksgiving with parents) and does the cardholder appear to have seasonal residences (for example snowbirds, with a northern residence in the summer and a southern residence in the winter).

General classifications can include popular travel weeks, popular lunch spots for commuters, indicators of residential spending (for example, spending for dry cleaning, drug store items, groceries, indicators of travel spending (for example purchases at souvenir shops), and purchases that identify logical time breaks and geography breaks.

Based on these classifications, logic for predicting an instantaneous location is created. A process for utilizing historic transaction activity to predict current/future location is created. The process can include one or more algorithms. Supporting aggregate data, based on transaction data from external sources, can be used in one or more algorithms.

At 18, the logic that is developed based on the various classifications of the data is applied to the transaction data. While good predictability of location of a cardholder (or user) or group of cardholders can be achieved, certain insights can be applied to achieve greater accuracy.

At 20, insights from general experience, and those based on a particular cardholder or group of cardholders, can be applied to assist in predicting or determining a present location or predicting a future location. Some examples of such insights are:

1. Based on lunchtime spending, commuter rail purchases, and reasonable commuting distance from the cardholder's residence, a cardholder works weekdays in New York City. During daytime on typical work days (non-holiday and non-weekend), the probability of the cardholder being in New York City is approximately ninety percent.

2. Based on historical transaction data, a cardholder has spent four of the last five Thanksgivings in Omaha, Nebr. There is an eighty percent probability that the cardholder will return to Omaha, Nebr. this Thanksgiving.

3. A cardholder, likely a college student, has spent the past three spring breaks travelling to a warm, domestic beach destination. It is likely that the cardholder will again travel to a warm, domestic beach destination during the upcoming spring break.

4. A cardholder spends summers in Fayetteville, W. Va. and winters in Lake Tahoe, Calif. It is likely that this person is a seasonal worker and will continue this pattern.

5. A cardholder spends every winter in a different ski town and returns to Alaska every summer. It is likely that this cardholder will return to Alaska each summer and depart for a ski town each winter.

Many additional insights, and refinements to these insights, mentioned above can be used. For example, if it is Friday night and a cardholder usually makes purchases away from home, the cardholder may be traveling to a location other than home.

If the purchase is not a point of sale transaction, but if it is determined to be made by the cardholder's home computer, the cardholder can be assumed to be at home.

At 22, a determination is made as to the location of a cardholder (or a group of cardholders out of a universe of cardholders) based on the logic or algorithm developed and the application of any relevant insights. The details of how this is accomplished are explained with respect to the discussion of FIG. 3 below.

In one embodiment, at 24, the logic (and possibly the insights) is run against historical data of a larger group (or larger universe of cardholders) to arrive at an estimate of a level of confidence that can be assigned to the predictions. This can be accomplished by obtaining subsequent cardholder transaction data, and comparing that transaction data to the predicted locations.

At 26, a list of cardholders, predicted locations for those cardholders and time windows for those locations, are produced as indicators of the locations of those cardholders.

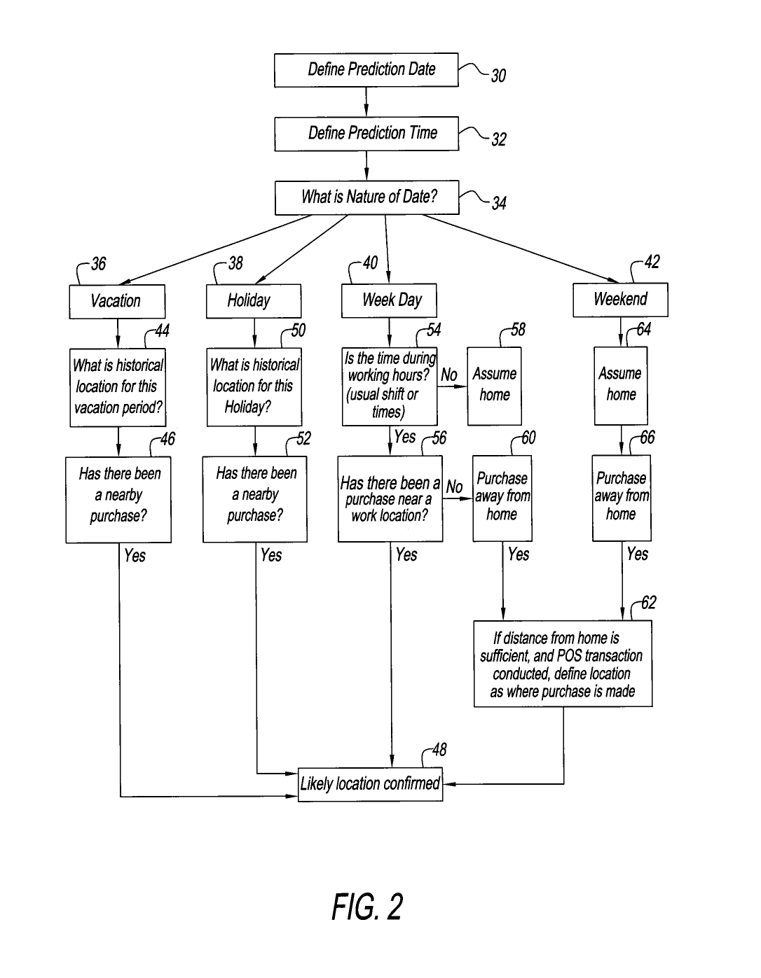

FIG. 2 illustrates one of many possible logic flows, and its use in determining the location of a cardholder, by implementing steps 16, 18, 20 and 22 of FIG. 1. In one embodiment of the present disclosure, cardholders can be identified based on a location and/or time of transactions. In this one embodiment, at 30 and 32, the prediction date and time, respectively, for when the location of the cardholder is to be predicted is entered via a user interface, as described with respect to FIG. 3. Times and dates in the future can be entered. According to this embodiment, the date and time include a particular date, e.g, 8:00 am, Mar. 15, 2014. According to another embodiment, the date and time are determined more generally, e.g., Wednesday mornings or the month of July or the first week of February. According to yet another embodiment, the current date and time are used to predict the current location of the cardholder.

At 34, a determination is made as to the nature of the date defined at 30. For purposes of illustration, the date can be a vacation date 36, a holiday 38, a week day 40 (other than a vacation day or a holiday), or a weekend day 42 (again, other than a vacation day or a holiday). In principle, other kinds of dates can be defined such as, for example, a work-at-home date, or a business trip date, if either of these events is likely based on the nature of a cardholder's past transactions. According to one embodiment, the nature of each day in a particular year can be specified by consulting a calendar for that year, as the date for holidays, such as Memorial Day, Labor Day, and Thanksgiving Day, will vary from year to year. According to another embodiment, the calendar includes a school calendar that indicates vacation periods (such as winter, spring and summer break) as well as holidays. Once a determination of the nature of the date is made at 34, flow passes to one of: steps 36-46 for a vacation date, steps 38-52 for a holiday date, steps 40-62 for a weekday date, or steps 42-62 for a weekend date.

At 44, historical data for the location of the cardholder during the particular vacation period is consulted. The historical location is assumed to be the location of the cardholder on the specified date. According to one embodiment, a cardholder's location during any particular vacation period is determined to be the location where card holder made the most, or the highest percentage of, POS transactions during similar historical vacation periods. For example, at 44, historical transaction data is accessed and it is determined that a cardholder conducted 90% of their electronic transactions (e.g., credit card transactions) at POS locations in Vermont during four of the last five winter breaks in Vermont. Based on this data, it is then determined that there is an eighty (80) percent probability that the cardholder will return to Vermont during the upcoming winter break. In this example, the resulting probability was calculated based on POS transactions occurring over a number of years, that is, the majority of transactions occurring during the vacation period four of the last five years occurred in Vermont resulting in the 80% confidence level for the associated prediction. According to other embodiments, a specific probability is calculated in anyone of several ways. According to one such embodiment, the probability associated with any prediction is a percentage of transactions made at POS locations in the predicted location during the most recent vacation period. Similar techniques can be applied to estimate probability for any prediction described herein.

At 46, cardholder purchase data is checked to determine if there is a point of sale purchase at or near the historical location for that date of the year. According to one embodiment, this check is accomplished at a time and date close to the desired prediction time. For example, if the desired prediction date is Jul. 1, 2014, locations of the transactions in the week leading up to the date are checked to determine if those locations indicate that the cardholder is traveling to the predicted location. A transaction that occurs at an airport, or at a location between the cardholder's normal location and the predicted destination, would indicate that the cardholder is travelling to the predicted location. If there has been such a purchase, the prediction is confirmed at 48 with a high degree of assumed accuracy. In the absence of one or more confirmatory transactions, the prediction may be delivered with a lower level of confidence or may be revised.

At 54, if the defined date is a holiday, historical data for the location of the cardholder on that holiday is consulted. The historical location is assumed to be the location of the cardholder on the specified date. According to one embodiment, a cardholder's location during any particular holiday period is determined to be the location where card holder made the most, or the highest percentage of, POS transactions during similar historical holiday periods. For example, at 54, historical transaction data is accessed and it is then determined that a cardholder conducted 90% of their electronic transactions (e.g., credit card transactions) at POS locations in Omaha, Nebr. during the last three consecutive Thanksgivings. Based on this transaction data, it is then determined there is a high probability that the cardholder will return to Omaha, Nebr. during the upcoming Thanksgiving holiday. According to one embodiment, a specific probability can be calculated and associated with the prediction of location. The probability could be calculated in any of several ways. According to an embodiment, the probability associated with any prediction is a percentage of transactions made at POS locations in the predicted location during the most recent holiday period. Alternatively, the probability is based on POS transactions occurring over a number of years. For example, the majority of transactions occurring during the holiday period three of the last five years occurred in location X resulting in a 60% confidence level for the associated prediction. Similar techniques can be applied to estimate probability for any prediction described herein. At 56, the cardholder purchase data is checked to determine if there is a point of sale purchase at or near the historical location for that date of the year. According to one embodiment, this check is accomplished at a time and date close to the desired prediction time. Analogous to the example discussed above at 46, if the desired prediction date is Jul. 1, 2014, locations of the transactions in the week leading up to that date are checked to determine if those locations indicate that the cardholder has or is traveling to the predicted location. A transaction that occurs at an airport, or at a location between the cardholder's normal location and the predicted destination, would indicate the cardholder is travelling to the predicted location. If there has been such a purchase, the prediction is confirmed, with a high degree of assumed accuracy, at 48. In the absence of one or more confirmatory transactions, the prediction may be delivered with a lower level of confidence or revised.

At 40, for a weekday, a determination is made at 54 whether the defined time is during working hours. As apparent from the discussion below, “weekday” as used herein describes a cardholder's typical working day and is not necessarily limited to traditional weekdays of Mondays through Fridays. According to one embodiment, a cardholder's working hours are determined by examining timing and location of POS transactions and identifying patterns in the timing and location. For example, a cardholder that transacts in a single location Monday through Friday at lunch times can be assumed to work at or near the location of the lunch transactions. As another example, a cardholder that makes regular transactions at one or more closely located POS locations (for example, restaurants and coffee shops) during a repeating time period (e.g., the hours of 8:00-4:00, the hours of 3:00-11:00, and the like) can be assumed to work during those hours at or near the location of the closely located POS. A cardholder's pattern of transactions are used to define the cardholder's normal working days and hours regardless of whether the cardholder works a traditional Monday through Friday 9:00-5:00 work week or a non-traditional work week. At 56, a determination is made whether there has been a purchase near the cardholder's work location. According to one embodiment, this check is accomplished at a time and date close to the desired prediction time. For example, if the desired prediction date is Jul. 1, 2014, locations of the transactions during the week of the predicted date or earlier on the day of the predicted date are checked to determine if they are consistent with the cardholder's typical workday pattern including location and timing. For example, a transaction that occurs at a gas station between the cardholder's home and work location would indicate the cardholder is, in fact, going to work. If such a transaction is found at 56, then a prediction that the cardholder is at work is confirmed with a high degree of assumed accuracy at 48. In the absence of one or more confirmatory transactions, the prediction may be delivered with a lower level of confidence or may be revised.

If the answer at 54 is No, then the defined time is outside normal working hours. As discussed above, a cardholder's working hours can be estimated from their transactions. Thus, at 58, the cardholder is assumed to be at home. However, if a point of sale purchase away from home is made at 60, then the distance from home to the location of the point of sale purchase (e.g., by using the address of the POS terminal) is determined at 62. If the distance is sufficiently large, such in a DMA or MSA other than one where the cardholder lives or works, the assumption is that the cardholder is away from home on at least a temporary basis, and the location of the cardholder is where the transaction has occurred. If the location is sufficiently close to the home of the cardholder, the assumption is that the cardholder is home. In either event, the location of the cardholder is confirmed at 48.

At 42, if the defined date is a weekend, historical data for the location of the cardholder on weekends is consulted. As apparent from this application, “weekend” as used herein describes a cardholder's typical days that are not spent working, and is not necessarily limited to traditional weekend days, namely Saturday and Sunday. According to one embodiment, a cardholder's typical weekend is established by looking for patterns in transaction data. According to another embodiment, the days of a cardholder's weekend are determined by examining timing and location of POS transactions and identifying patterns in the timing and location. For example, if a cardholder regularly transacts in several locations near the location of their residence on certain days, e.g., Sunday and Monday, then methods consistent with the present disclosure determines the cardholder does not work on those days. That is, those days constitute the cardholder's “weekend”. A cardholder's pattern of transactions can be used to define their normal working days and hours, and their normal days and times off, regardless of whether they work a traditional Monday through Friday 9:00 AM to 5:00 PM work week or a non-traditional work week.

When the historical location of a cardholder on weekends is determined according to methods of the present disclosure, then at 64, the predicted location of a cardholder on future weekend days is determined. According to one embodiment, the historical location of the cardholder on weekends is determined to be the location of the cardholder on the specified weekend day.

At 66, the cardholder's transactions are checked to determine if there is a transaction at a significant distance from the cardholder's home, that is, “away from home.” The existence of such a transaction indicates that a cardholder is not at home as determined at 64. According to one embodiment, any purchase that diverges from a cardholder's normal weekday travel distance by more than some percentage, such as 1000%, (as determined by the address of the POS transaction and the address of the cardholder's residence), is considered a transaction away from home. According to another embodiment, a cardholder's normal weekend travel distance is the average distance between POS transaction terminals and a cardholder's residence that occur on that cardholder's normal weekend. For example, assume a cardholder typically transacts at four POS transaction terminals during their normal weekend. The four transaction terminals are 3 miles, 5 miles, 6 miles and 6 miles from the residence of the cardholder, respectively. In this example, the cardholder's normal weekend travel distance is five miles, as computed by (3+5+6+6)/4. According to this embodiment, if a purchase takes place more than fifty miles from the cardholder's residence, then the location of that point of sale transaction terminal is determined at 62 to be the cardholder's location. According to another embodiment, the divergence from a cardholder's normal travel distance is based on the population density of the region within which a cardholder normally conducts transactions.

According to other embodiments, methods consistent with the current disclosure determine the most likely dates and times to determine a cardholder's location. That is, based on a cardholders spending pattern, it can be determined that they are, at a particular location at a particular time and day, a calculated percentage of the time. For example, if cardholder A stops at the same coffee shop at the same time every weekday morning, it can be determined that cardholder A is likely to be at that same coffee shop at that same time on any future weekday. A confidence measure is calculated for such a prediction by determining the number of possible weekdays the cardholder visited that coffee shop at that particular time and comparing that with the number of possible weekdays. For example, assume cardholder A visits that same coffee shop between the hours of 7:00 am and 7:30 am 17 weekdays during the month of October. Assume also that there were 23 weekdays during that same October. According to this example, there was a 73.9% chance that the cardholder visited that coffee shop during weekday mornings that October. That percentage could then be applied as a confidence measure associated with predicting that cardholder's location during weekday mornings between 7:00 am and 7:30 am. Such a confidence measure can be calculated over any time domain and applied to future times.

Referring to FIG. 3, each merchant that accepts a payment card has on its premises at least one card swiping machine or point of sale device 80, of a type well known in the art, for initiating customer transactions. These point of sale devices 80A, 80B, . . . 80N, generally have a keyboard data pad for entering data when a card's magnetic coding becomes difficult to read, or for the purpose of entering card data resulting from telephone calls during which the customer provides card data by telephone. Point of sale devices 80A, 80B, . . . 80N are connected by a suitable card payment network 85 to a transaction database 90 associated with or within network 85 that stores information concerning the transactions. An example of such a network 85 is BankNet, operated by MasterCard International Incorporated. BankNet is a four party payment network that connects a card issuer, a card holder, merchants, and an acquiring bank, as is well known in the art. In another embodiment, network 85 can be a three party system. In any such embodiment, POS devices 80 do not have direct access to transaction database 90.

Information in database 90 can be accessed by a bank or network operator access device 100, such as a computer having a processor 105 and a memory 110. Users of device 100 can be employees of the bank or a payment network operator who are doing research or development work, such as running an inquiry, to improve the logic or are investigating the accuracy of the existing logic, used to predict the location of a cardholder.

Transaction records stored in transaction database 90 contain information that is highly confidential and must be maintained confidential to prevent fraud and identity theft. The transaction records stored in transaction database 90 are sent through a filter 120 that removes confidential information, but retains records concerning all other transaction related details discussed above, preferably in real time. The filtered data is stored in a filtered transaction database 130 that can be accessed as described below. The data in the filtered transaction database 130 can be stored in any type of memory, including a hard drive, a flash memory, on a CD, in a RAM, or any other suitable memory.

The following example of an approach to accessing the data involves a mobile telephone. However, it is understood that that there are various other approaches, technologies and pathways that can be used, including direct access by employees of the card issuing bank or a payment network operator.

A mobile telephone 140 having a display 145 can have a series of applications or applets thereon including an applet or application program (hereinafter an application) 150 for use with the embodiment described herein. Mobile telephone 140 can also be equipped with a GPS receiver 160 so that its position is always known.

Mobile telephone 140 can be used to access a website 170 on the Internet, via an Internet connected Wi-Fi hot spot 190 (or by any telephone network, such as a 3G or 4G system, on which mobile telephone 140 communicates), by using application 150. Website 170 is linked to database 130 so that authorized users of website 170 can have access to the data contained therein. These users can be employees of the bank or network operators who are making inquiries as described above with bank or operator access device 100.

Web site 170 has a processor 180 for assembling data from filtered transaction database 130 for responding to inquiries, as more fully discussed above with respect to FIG. 1 and FIG. 2. A memory 185 associated with web site 170, having a non-transitory computer readable medium, stores computer readable instructions for use by processor 180 in implementing the operation of the disclosed embodiment.

It will be understood that the present disclosure can be embodied in a computer readable non-transitory storage medium storing instructions of a computer program which when executed by a computer system results in performance of steps of the method described herein. Such storage media can include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A system for predicting a present or future location of a cardholder who has made one or more payment card transactions, comprising:
an electronic storage device having a database of the payment card transactions stored therein;
an access path for allowing access to data concerning the payment card transactions in the database, the data concerning the payment card transactions including when and where point of sale transactions have taken place; and
a processor for conducting a process to analyze the data concerning the payment card transactions, the processor being programmed with logic that provides a prediction of where the cardholder will be located at a present or a selected future time based on the payment card transactions.

2. The system of claim 1, wherein at the present time, the processor predicts the present location of the cardholder.

3. The system of claim 1, wherein the selected time is a predetermined future time, and wherein the processor predicts the location of the cardholder at that predetermined future time.

4. The system of claim 1, wherein prediction accuracy is also evaluated to derive a predicted location of the cardholder at a first selected time, additional data concerning the payment card transactions is evaluated to determine an actual location of the cardholder at the first selected time, and a comparison is made between the predicted location and the actual location.

5. The system of claim 1, wherein the database includes data concerning payment card transactions of a universe of cardholders, wherein the logic is applied to data concerning payment card transactions from a first group of cardholders in the universe of cardholders and subsequently to data concerning payment card transactions from a second group of cardholders in the universe of cardholders, with the second group of cardholders being larger than the first group of cardholders, to determine accuracy of prediction of the logic.

6. The system of claim 1, wherein the data concerning the payment card transactions is filtered by at least one filter selected from the group consisting of time, metropolitan statistical area, and designated market area.

7. The system of claim 1, wherein the logic is configured to receive as input a time and a date, and to determine location of the cardholder at that time and date.

8. The system of claim 7, wherein the logic analyzes the data concerning the payment card transactions to determine whether the date is one selected from the group consisting of a vacation day, a holiday, a week day, and a weekend day.

9. The system of claim 1, wherein the logic makes a determination whether the cardholder has made a purchase near a predicted location at the selected future time.

10. The system of claim 1, further comprising using general insights as a factor in predicting the present or future location of the cardholder, wherein the general insights include historical location data of the cardholder in the database.

11. A method for predicting the present or future location of a cardholder who has made payment card transactions, comprising:
storing in an electronic storage device having a database, data concerning the payment card transactions;
accessing the data concerning the payment card transactions in the database, wherein the accessed data includes data of the time when point of sale transactions took place; and
analyzing the accessed data with a processor in accordance with a programmed logic to predict the present or future location where the cardholder will be at the present or selected future time, respectively, based on the payment card transactions.

12. The method of claim 11, wherein at the present time, the processor predicts the present location of the cardholder.

13. The method of claim 11, wherein the selected time is a predetermined future time, and wherein the processor predicts the location of the cardholder at that predetermined future time.

14. The method of claim 11, further comprising evaluating prediction accuracy:
deriving the predicted location of the cardholder at a first selected time;
evaluating additional transaction data to determine an actual location of the cardholder at the first selected time, and
comparing the predicted location and the actual location.

15. The method of claim 11, wherein the database includes data concerning payment card transactions of a universe of cardholders, wherein the logic is applied to data concerning payment card transactions from a first group of cardholders in the universe of cardholders and subsequently to data concerning the payment card transactions from a second group of cardholders in the universe of cardholders, with the second group of cardholders being larger than the first group of cardholders, to determine accuracy of prediction of the logic.

16. The method of claim 11, further comprising filtering the data concerning the payment card transactions by at least one filter selected from the group consisting of time, metropolitan statistical area, and designated market area.

17. The method of claim 11, further comprising receiving as input in the logic a time and a date, and predicting the location of the cardholder at that time and date.

18. The method of claim 17, further comprising analyzing the accessed data concerning the payment card transactions to determine whether the date is one selected from the group consisting of a vacation day, a holiday, a week day, and a weekend day.

19. The method of claim 11, further comprising using general insights as a factor in predicting the present or future location of the cardholder, wherein the general insights include historical location data of the cardholder in the database.

20. A computer readable non-transitory storage medium storing instructions of a computer program which when executed by a computer system results in performance of steps of a method for predicting the location of a cardholder who has made payment card transactions, comprising:
storing in an electronic storage device having a database with data concerning the transactions;
accessing the data concerning the transactions in the database, the accessed data including data on when point of sale transactions have taken place; and
analyzing the accessed data with a processor in accordance with a programmed logic to predict the present or future location of the cardholder at a selected time, wherein the selected time is the present time or any desired future time, based on the payment card transactions.
